(19) United States
(12) Patent Application Publication
(10) Pub. No.: US 2021/0199613 A1
(43) Pub. Date: Jul. 1, 2021

(54) Method for calculating damage of carbon fiber reinforced polymer composite under action of single lightning current component with fast-rising rate

(71) Applicant: XI`AN JIAOTONG UNIVERSITY, Xi'an, Shaanxi (CN)

(72) Inventors: Jinru Sun, Xi'an, Shaanxi (CN); Xueling Yao, Xi'an, Shaanxi (CN); Xiangyu Tian, Xi'an, Shaanxi (CN); Jingliang Chen, Xi'an, Shaanxi (CN)

(21) Appl. No.: 17/059,203

(22) PCT Filed: Oct. 11, 2019
(86) PCT No.: PCT/CN2019/110571

§ 371 Date: Nov. 25, 2020

(30) Foreign Application Priority Data
Dec. 6, 2018 (CN) 201811489482.6

(51) Int. Cl. G01N 27/20; G06F 30/20

(52) U.S. Cl. CPC G01N 27/20; G06F 2119/08; G06F 30/20

(57) ABSTRACT

A method for calculating the damage of a carbon fiber composite reinforced polymer (CFRP) composite under an action of a single lightning current component with a fast-rising rate is disclosed. Through the obtained dynamic impedance curves of the CFRP composite under the action of the non-destructive lightning current component, the anisotropic conductivity of the CFRP composite under the action of the single lightning current component with specified parameters is extrapolated based on pre-designed lightning damage simulation conditions. The anisotropic conductivity is taken as the initial condition of the conductivity of the CFRP composite in the coupled thermoelectric simulation model, which is able to better simulate the real lightning effect on the CFRP composite, and is able to more accurately obtain the lightning damage of the CFRP composite and analyze the relationship between the lightning damage parameters.

### CROSS REFERENCE OF RELATED APPLICATION

This is a U.S. National Stage under 35 U.S.C 371 of the International Application PCT/CN2019/110571, filed Oct. 11, 2019, which claims priority under 35 U.S.C. 119(a-d) to CN 201811489482.6, filed Dec. 6, 2018.

### BACKGROUND OF THE PRESENT INVENTION

### Field of Invention

The present invention belongs to a method for simulating and calculating lightning damage of a carbon fiber reinforced polymer composite, and more particularly to a method for calculating damage of a carbon fiber reinforced polymer composite under an action of a single lightning current component with a fast-rising rate.

### Description of Related Arts

Fiber reinforced composites not only have the characteristics of low density, high strength, high modulus, high temperature resistance and chemical corrosion resistance, but also have the soft processability of textile fibers, and are widely used in various fields such as aerospace, military and civil industries. With the improvement of aircraft design and the advancement of fiber reinforced composite technology, carbon fiber reinforced polymer (CFRP) composites are increasingly used in large civilian aircrafts, military aircrafts, unmanned aerial vehicles (UAVs) and stealth aircrafts. In 1960, the amount of CFRP composites on McDonnell Douglas DC-9 was less than 1%; by the end of 2011, the main wing, tail wing, fuselage and floor of Boeing 787 Dreamliner are basically made from CFRP composites which represent 50% of aircraft weight, and the proportion of CFRP composites on the Airbus A350WA reached 53 wt %.

Compared with the aluminum, steel and titanium alloy materials traditionally used in aircrafts, CFRP composite has poor electrical conductivity. Generally speaking, the resistivity of the CFRP composite laminate in the longitudinal fiber direction is on the order of 10⁻⁵ Ω·m, the resistivity thereof in the transverse fiber direction is on the order of 10⁻¹ Ω·m, and the in-thickness resistivity is greater, which prevents the CFRP composite laminate from having the ability to quickly transfer or diffuse heat and accumulated charges in a short time like metal materials under lightning strikes, so that the accumulated energy causes the temperature of CFRP composite to rise sharply, resulting in severe damages such as fiber breakage, resin pyrolysis, and delamination of CFRP composite.

The EU and US standard stipulate the direct lightning test requirements and the lightning current component of aircrafts, wherein the lightning current component includes component A (first lightning return component) or Ah (transition component of the first lightning return), component B (intermediate current component), component C/C* (continuous current component) and component D (subsequent return component) current waves, here, the lightning current components A, Ah and D have high peaks (which are respectively 200 kA, 150 kA and 100 kA) and fast-rising rates; the lightning current component B is a double exponential wave with an average current of 2 kA, a short rise time, and a duration of several milliseconds, or a square wave current with a slow rise; the lightning current component C is a current wave with a slow rise and a duration of hundreds of milliseconds.

Since the advent of CFRP composite, mechanical properties of CFRP composite have the research hotspots, and many researchers obtained the relationship between the mechanical impact parameters and the residual tensile strength, residual compressive strength, damage area and damage depth of CFRP composite. At present, the research on lightning damage of CFRP composite has gained more and more attention. Since experimental investigation are limited by the realization of the extremely high-intensity and transient duration of lightning current component, many researchers have established a coupled thermoelectric model of lightning damage of CFRP composite under the action of a single lightning current component A, and then preliminarily obtained the influence laws of lightning damage area and lightning damage depth of CFRP composite through simulation and calculation. This coupled thermoelectric model is generally established based on the variation of impedance with the temperature threshold or the degree of pyrolysis. However, the initial condition of the coupled thermoelectric model is the conductivity of the CFRP composite under the small static (DC) current, completely ignoring the significant difference between the conductivity of CFRP composite under the action of the lightning current component and the small static DC current, as well as the nonlinear conductive characteristics of the CFRP composite under the action of the lightning current component. Therefore, the results of the simulation and calculation obtained from the DC-conductivity-based simulation model are significantly different from the actual lightning damage conditions. Patent ZL 2015104538855 discloses “a method and a device for measuring impedance characteristics of a carbon fiber composite material under an action of non-destructive lightning current component”. Moreover, the research results of related literatures also show that: due to structural characteristics and processing technologies, the conductivity of CFRP composite exhibits obvious nonlinear conductive characteristics under the action of lightning current component.

### SUMMARY OF THE PRESENT INVENTION

An object of the present invention is to provide a method for calculating damage of a carbon fiber reinforced polymer (CFRP) composite under an action of a single lightning current component with a fast-rising rate. This method is able to accurately obtain the relationship between the lightning damage of the CFRP composite and parameters of the lightning current component, so as to provide the theoretical basis for researches and applications of designing and processing technologies of the CFRP composite.

To achieve the above object, the present invention provides technical solutions as follows.

A method for calculating damage of a carbon fiber reinforced polymer (CFRP) composite under an action of a single lightning current component with a fast-rising rate comprises steps of:

(1) building a test platform for testing the lightning current component with the fast-rising rate, and obtaining three-dimensional anisotropic quasi-dynamic volt-ampere characteristic curves of the CFRP composite under the action of the lightning current component;

(2) numerically fitting the obtained three-dimensional anisotropic quasi-dynamic volt-ampere characteristic curves of the CFRP composite under the action of the lightning current component, and obtaining a mathematical expression between an impedance or conductivity of the CFRP composite and waveform parameters of the lightning current component;

(3) according to pre-designed lightning damage simulation conditions of the CFRP composite, extrapolating the conductivity of the CFRP composite on a basis of the mathematical expression obtained by the step of (2), and then calculating a three-dimensional anisotropic conductivity of the CFRP composite under an action of a single lightning current component A, Ah or D with a specified peak lightning current component, wherein the peak lightning current component is in a range of 100 kA to 200 kA, and taking the three-dimensional anisotropic conductivity as an initial condition of the conductivity of the CFPR composite in a coupled thermoelectric model with the fast-rising lightning current component;

(4) setting a layup structure of a CFRP composite laminate to be modeled and simulated, and setting a density, specific heat, thermal conductivity and mechanical strength of the CFRP composite in the coupled thermoelectric model;

(5) setting a boundary condition of the coupled thermoelectric model for CFRP composite lightning damage simulation, wherein the boundary condition comprises an ambient temperature, a critical temperature for material conductivity change, and a heat conduction and radiation coefficient between the CFRP composite and surrounding environment during lightning strikes;

(6) designing simulation calculation meshing in the coupled thermoelectric model of the CFRP composite, setting parameters of the lightning current component with the fast-rising rate, and calculating a thermoelectric effect in a process of the lightning current component interacting with the CFRP composite;

(7) after increasing a temperature of the CFRP composite to the critical temperature, resin material inside the CFRP composite pyrolyzing, wherein with an increase degree of resin pyrolysis, an electrical conductivity, the thermal conductivity and mechanical properties of the CFRP composite are all changed dramatically, and the electrical conductivity thereof is changed from insulation or high-resistance state to good conductive state; and

(8) according to a temperature and pyrolysis degree of the CFRP composite under the action of the single lightning current component which are obtained through simulation and calculation, analyzing a lightning damage area and a lightning damage depth of the CFRP composite.

Preferably, the test platform for testing the lightning current component comprises a lightning current component generating circuit, wherein a high voltage terminal of the lightning current component generating circuit is electrically connected with an upper surface of a tested CFRP composite sample, and a low voltage terminal of the lightning current component generating circuit is electrically connected with a lower surface of the tested CFRP composite sample and connected with ground;

the test platform further comprises a pulse voltage sampling unit for obtaining a voltage of the tested CFRP composite sample, and a lightning current sampling unit for obtaining a current through the tested CFRP composite sample, wherein both the pulse voltage sampling unit and the lightning current sampling unit are connected with a computer measurement and control analysis unit.

Preferably, the lightning current component generating circuit comprises an RLC (resistor-inductor-capacitor) circuit or a CROWBAR circuit.

Preferably, the lightning current component generating circuit further comprises a controllable DC (direct current) charging power supply and an energy storage capacitor unit connected with the controlled DC charging power supply in parallel, wherein a high voltage terminal where the controllable DC charging power supply is connected with the energy storage capacitor unit is connected with a discharge switch, a waveform adjustment resistor, and a waveform adjustment inductor in series; the waveform adjustment inductor is electrically connected with the upper surface of the tested CFRP composite sample, a lower voltage terminal of the energy storage capacitor unit is electrically connected with the lower surface of the tested CFRP composite sample and connected with the ground; the lightning current component with the fast-rising rate is obtained through controlling parameters of the energy storage capacitor unit, the waveform adjustment resistor and the waveform adjustment inductor.

Preferably, a peak current of the test platform is in a range of tens of amps to thousands of amps.

The present invention has some beneficial effects as follows.

According to the method for calculating damage of the CFRP composite under the action of the single lightning current component provided by the present invention, the boundary condition of the dynamic impedance of the CFRP composite is provided, that is, through the obtained three-dimensional anisotropic quasi-dynamic impedance curves of the CFRP composite under the action of the non-destructive lightning current component, the three-dimensional anisotropic conductivity of the CFRP composite under the action of the single lightning current component with specified parameters is extrapolated based on pre-designed lightning damage simulation conditions. The three-dimensional anisotropic conductivity is taken as the initial condition of the conductivity of the CFRP composite in the coupled thermoelectric model, which is able to better simulate the real lightning strike process of the CFRP composite, and is able to more accurately obtain the lightning damage of the CFRP composite and analyze the relationship between the lightning damage parameters, including lightning damage area and depth, and the parameters of the lightning current component, and is able to explore the lightning damage mechanism of the CFRP composite, thus laying a theoretical foundation for researches on designing and processing technologies, performance improvements and engineering applications of the CFRP composite.

### BRIEF DESCRIPTION OF THE DRAWINGS

FIG. 1 is a block diagram of a test platform for testing a lightning current component provided by the present invention.

FIG. 2a is a schematic diagram of an RLC (resistor-inductor-capacitor) circuit.

FIG. 2b is a schematic diagram of a CROWBAR circuit.

FIG. 3 is a test flow chart of a dynamic conductivity of a CFRP composite under an action of a non-destructive lightning current component with a fast-rising rate.

FIG. 4 is a simulation calculation flow chart of lightning damage of the CFRP composite under the action of the single lightning current component with the fast-rising rate provided by the present invention.

### DETAILED DESCRIPTION OF THE PREFERRED EMBODIMENT

The present invention is further described in detail with reference to accompanying drawings and specific embodiments as follows, which are not intended to limit the present invention.

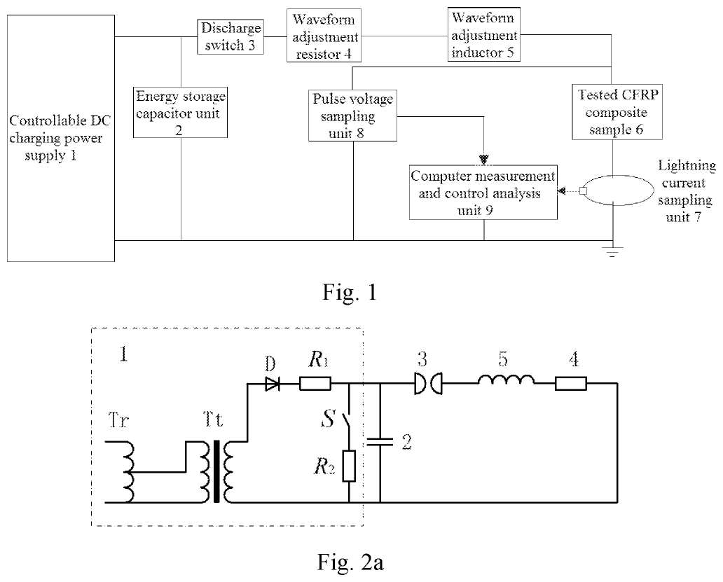

Referring to FIG. 1, a test platform for testing a lightning current component provided by the present invention is illustrated, which comprises a controllable DC (direct current) charging power supply 1, an energy storage capacitor unit 2, a discharge switch 3, a waveform adjustment resistor 4, a waveform adjustment inductor 5, a tested CFRP composite sample 6, a lightning current sampling unit 7, a pulse voltage sampling unit 8 and a computer measurement and control analysis unit 9.

The energy storage capacitor unit 2 is connected with the controllable DC charging power supply 1 in parallel, a high voltage terminal where the controllable DC charging power supply 1 is connected with the energy storage capacitor unit 2 is connected with the discharge switch 3, the waveform adjustment resistor 4, and the waveform adjustment inductor 5 in series. The controllable DC charging power supply 1, the energy storage capacitor unit 2, the discharge switch 3, the waveform adjustment resistor 4, and the waveform adjustment inductor 5 form a lightning current component generating circuit. A high voltage terminal of the lightning current component generating circuit is electrically connected with an upper surface of the tested CFRP composite sample 6, and a low voltage terminal of the lightning current component generating circuit is electrically connected with a lower surface of the tested CFRP composite sample 6 and connected with ground. The lightning current component with the fast-rising rate is obtained through controlling parameters of the energy storage capacitor unit 2, the waveform adjustment resistor 4 and the waveform adjustment inductor 5.

The test platform further comprises a pulse voltage sampling unit 8 for obtaining the voltage of the tested CFRP composite sample 6, and a lightning current sampling unit 7 for obtaining the current through the tested CFRP composite sample 6. Both the pulse voltage sampling unit 8 and the lightning current sampling unit 7 are connected with the computer measurement and control analysis unit 9. Through controlling the parameters of the energy storage capacitor unit 2, the waveform adjustment resistor 4 and the waveform adjustment inductor 5, a lightning current component A with a fast-rising rate and a lightning current component D with a fast-rising rate are obtained. Take the lightning current component A as an example to illustrate an adjustment method of loop parameters. For other lightning current component loops, the loop parameters are able to be selected through referring to this adjustment method.

The lightning current component A satisfies an expression of:

i(t)=I₀(e^{-αt}−e^{-βt}), wherein α=11354 s⁻¹ and β=647265 s⁻¹.

Accordingly, a rise time T₁ and a half peak time T₂ of the lightning current component A are T₁=3.56 μs and T₂=69 μs, respectively.

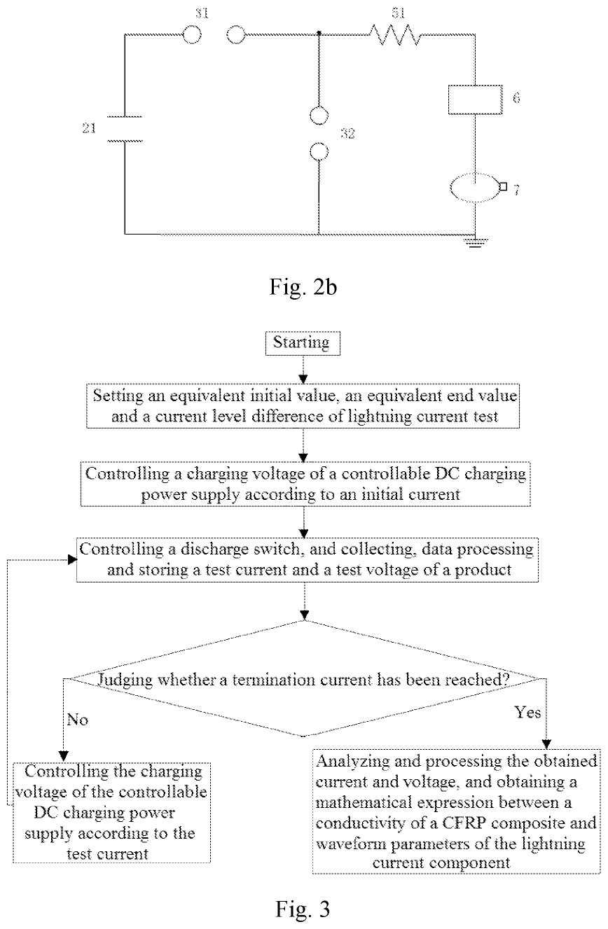

Referring to FIGS. 2a and 2b, the lightning current component A is able to be generated by an RLC (resistor-inductor-capacitor) circuit shown in FIG. 2a or a CROWBAR circuit shown in FIG. 2b.

If the lightning current component A with the fast-rising rate is generated by the RLC circuit shown in FIG. 2a, the loop parameters are selected as follows.

$${i}_{m}^{*} = {i}_{m} / \frac{{U}_{0}}{\sqrt{L C}} \\ {T}_{1}^{*} = {T}_{1} / \sqrt{L C} \\ ξ = R / 2 \sqrt{L / C} , \qquad ( I )$$

wherein in the formula (I), C is a capacitance of the energy storage capacitor unit 2, L is an inductance of the waveform adjustment inductor 5, R is a resistance of the waveform adjustment resistor 4, U₀ is a charging voltage of the energy storage capacitor unit 2, T₁ is a front time of the lightning current component, iₘ is a peak value of an output current of the RLC circuit, ξ is a damping coefficient of the RLC circuit shown in FIG. 2a, T₁* is a normalization coefficient of the front time, iₘ* is a normalized peak coefficient.

Three equations of the formula (I) contain four unknown numbers, so the formula (I) has infinitely many solutions. If the capacitance of the energy storage capacitor unit is assumed, related parameters are able to be selected according to Table 1 as follows.

TABLE 1
Selection of the parameters of the lightning current component A

| | Capacitance (C)/ | Resistance (R)/ | Inductance (L)/ |
|---|---|---|---|
| Serial No. | μF | Ω | μH |
| 1 | 100 | 0.9 | 1.4 |
| 2 | 50 | 1.8 | 2.8 |
| 3 | 25 | 3.6 | 4.2 |
| . . . | . . . | . . . | . . . |

As shown in FIG. 2a, the controllable DC charging power supply comprises a voltage regulator Tr, a transformer Tt, a rectifier diode D and a charging resistor R₁; a switch S and a resistor R₂ define a safety protection circuit for the energy storage capacitor unit.

The lightning current component A with the fast-rising rate is also generated by the CROWBAR circuit shown in FIG. 2b. Referring to FIG. 2b, the CROWBAR circuit comprises an energy storage capacitor 21, a main discharge switch 31, a CROWBAR switch 32 and a waveform forming inductor 51.

Referring to FIG. 3, the test platform is built based on the parameters shown in Table 1 and the circuit shown in FIG. 1. Then, the tested carbon fiber sample 6 is shown in the circuit of FIG. 1. The upper surface of the tested CFRP composite sample 6 is electrically connected with the high voltage terminal of the lightning current component generating circuit, and the lower surface of the tested CFRP composite sample 6 is electrically connected with the low voltage terminal of the lightning current component generating circuit. According to the measurement method disclosed by Patent ZL 2015104538855, the three-dimensional anisotropic quasi-dynamic volt-ampere characteristic curves of the CFRP composite under the action of the lightning current component is obtained. The obtained three-dimensional anisotropic quasi-dynamic volt-ampere characteristic curves of the CFRP composite under the action of non-destructive lightning strikes is fitted numerically, so as to obtain a mathematical expression between an anisotropic impedance or conductivity of the CFRP composite and the parameters of the lightning current component A, Ah or D.

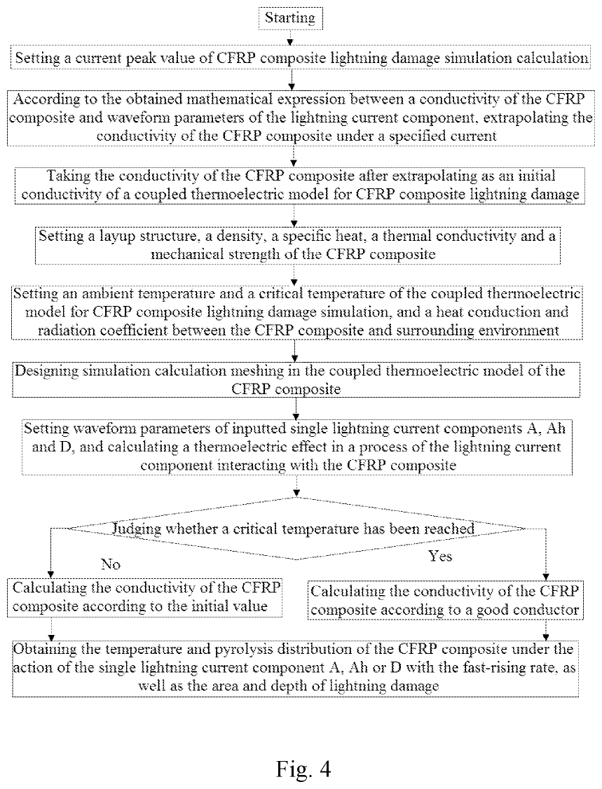

Referring to FIG. 4, a method for calculating lightning damage of a CFRP composite comprises steps of:

(1) presetting lightning damage simulation conditions of the CFRP composite, calculating three-dimensional anisotropic conductivities of the CFRP composite under an action of a single lightning current component A (or Ah or D) with a specified parameter (peak current), and taking the three-dimensional anisotropic conductivities as initial values of conductivities of the CFRP composite in a coupled thermoelectric model;

(2) according to actual situations, setting a layup structure of a CFRP composite laminate, and setting simulation parameters of the coupled thermoelectric model for CFRP composite lightning damage simulation, including a density, specific heat, thermal conductivity and the mechanical strength of the CFRP composite;

(3) setting a boundary condition of the coupled thermoelectric model for the CFRP composite lightning damage simulation, wherein the boundary condition comprises an ambient temperature, and a radiation coefficient between the CFRP composite and surrounding environment during the lightning strikes;

(4) designing simulation calculation meshing in the CFRP composite in the coupled thermoelectric model, setting parameters of the lightning current component, simulating and calculating a thermoelectric effect in a process of the lightning current component interacting with the CFRP composite;

(5) after increasing a temperature of the CFRP composite to a critical value, resin inside the CFRP composite pyrolyzing, wherein with an increase degree of resin pyrolysis, an electrical conductivity, a thermal conductivity and mechanical properties of the CFRP composite are all changed dramatically, and the electrical conductivity thereof is changed from insulation or high-resistance state to good conductive state; and

(6) according to a temperature and pyrolysis degree of the CFRP composite under the action of the single lightning current component which are obtained through simulation and calculation, analyzing a lightning damage area and a lightning damage depth of the CFRP composite.

Finally, it should be noted that the above embodiment is only used to illustrate the technical solution of the present invention and is not the limitation to the present invention. Although the present invention has been described in detail with reference to the above embodiment, those skilled in the art should understand that: the specific embodiment of the present invention is still able to be modified or equivalently replaced, and any modification or equivalent replacement that does not deviate from the spirit and scope of the present invention shall be covered by the scope of the claims.

1. A method for calculating damage of a carbon fiber reinforced polymer (CFRP) composite under an action of a single lightning current component with a fast-rising rate, the method comprising steps of:
(1) building a test platform for testing the lightning current component with the fast-rising rate, and obtaining three-dimensional anisotropic quasi-dynamic volt-ampere characteristic curves of the CFRP composite under the action of the lightning current component;
(2) numerically fitting the obtained three-dimensional anisotropic quasi-dynamic volt-ampere characteristic curves of the CFRP composite under the action of the lightning current component, and obtaining a mathematical expression between an impedance or conductivity of the CFRP composite and waveform parameters of the lightning current component;
(3) according to pre-designed lightning damage simulation conditions of the CFRP composite, extrapolating the conductivity of the CFRP composite on a basis of the mathematical expression obtained by the step of (2), and then calculating a three-dimensional anisotropic conductivity of the CFRP composite under an action of a single lightning current component A, Ah or D with a specified peak lightning current component, wherein the peak lightning current is in a range of 100 kA to 200 kA, and taking the three-dimensional anisotropic conductivity as an initial condition of the conductivity of the CFRP composite in a coupled thermoelectric model with the fast-rising rate lightning current component;
(4) setting a layup structure of a CFRP composite laminate to be modeled and simulated, and setting a density, specific heat, thermal conductivity and mechanism strength of the CFRP composite in the coupled thermoelectric model;
(5) setting a boundary condition of the coupled thermoelectric model for CFRP composite lightning damage simulation, wherein the boundary condition comprises an ambient temperature, a critical temperature for material conductivity change, and a heat conduction and radiation coefficient between the CFRP composite and surrounding environment during lightning strikes;
(6) designing simulation calculation meshing in the coupled thermoelectric model of the CFRP composite, setting parameters of the lightning current component with the fast-rising rate, and calculating a thermoelectric effect in a process of the lightning current component interacting with the CFRP composite;
(7) after increasing a temperature of the CFRP composite to the critical temperature, resin inside the CFRP composite pyrolyzing, wherein with an increase degree of resin pyrolysis, an electrical conductivity, the thermal conductivity and mechanical properties of the CFRP composite are all changed dramatically, and the electrical conductivity thereof is changed from insulation or high-resistance state to good conductive state; and
(8) according to a temperature and pyrolysis degree of the CFRP composite under the action of the single lightning current component which are obtained through simulation and calculation, analyzing a lightning damage area and a lightning damage depth of the CFRP composite.

2. The method according to claim 1, wherein the test platform for testing the lightning current component comprises a lightning current component generating circuit, wherein a high voltage terminal of the lightning current component generating circuit is electrically connected with an upper surface of a tested CFRP composite sample (6), and a low voltage terminal of the lightning current component generating circuit is electrically connected with a lower surface of the tested CFRP composite sample (6) and connected with ground;
the test platform further comprises a pulse voltage sampling unit (8) for obtaining a voltage of the tested CFRP composite sample (6), and a lightning current sampling unit (7) for obtaining a current flowing through the tested CFRP composite sample (6), wherein both the pulse voltage sampling unit (8) and the lightning current sampling unit (7) are connected with a computer measurement and control analysis unit (9).

3. The method according to claim 2, wherein the lightning current component generating circuit comprises an RLC (resistor-inductor-capacitor) circuit or a CROWBAR circuit.

4. The method according to claim 3, wherein the test platform further comprises a controllable DC (direct current) charging power supply (1) and an energy storage capacitor unit (2) connected with the controlled DC charging power supply (1) in parallel, wherein a high voltage terminal where the controllable DC charging power supply (1) is connected with the energy storage capacitor unit (2) is connected with a discharge switch (3), a waveform adjustment resistor (4), and a waveform adjustment inductor (5) in series; the waveform adjustment inductor (5) is electrically connected with the upper surface of the tested CFRP composite sample (6), a lower voltage terminal of the energy storage capacitor unit (2) is electrically connected with the lower surface of the tested CFRP composite sample (6) and connected with the ground; the lightning current component with the fast-rising rate is obtained through controlling parameters of the energy storage capacitor unit (2), the waveform adjustment resistor (4) and the waveform adjustment inductor (5).

5. The method according to claim 1, wherein a peak current of the test platform is in a range of tens of amps to thousands of amps.

6. The method according to claim 2, wherein a peak current of the test platform is in a range of tens of amps to thousands of amps.

7. The method according to claim 3, wherein a peak current of the test platform is in a range of tens of amps to thousands of amps.

8. The method according to claim 4, wherein a peak current of the test platform is in a range of tens of amps to thousands of amps.
